(19) United States
(12) Patent Application Publication
(10) Pub. No.: US 2016/0045823 A1
(43) Pub. Date: Feb. 18, 2016

(54) COMPUTER-IMPLEMENTED GAME WITH MODIFIED OUTPUT

(71) Applicant: GIGATAUR CORPORATION, Ottawa (CA)

(72) Inventors: Eric DALRYMPLE, Ottawa (CA); Wes TAM, Ottawa (CA); Debbie PINARD, Dunrobin (CA)

(73) Assignee: GIGATAUR CORPORATION, Ottawa (CA)

(21) Appl. No.: 14/782,429

(22) PCT Filed: Apr. 3, 2013
(86) PCT No.: PCT/CA13/00317

§ 371 Date: Oct. 5, 2015

(51) Int. Cl. A63F 13/30; A63F 13/212; A63F 13/33; A63F 13/25; A63F 13/32; A63F 13/215; A63F 13/213

(52) U.S. Cl. CPC A63F 13/30; A63F 13/215; A63F 13/212; A63F 13/213; A63F 13/25; A63F 13/32; A63F 13/33

(57) ABSTRACT

A computer-implemented game resident on a device has a game logic module for controlling operation of the game to create sensory output for presentation to a player. One or more inputs responsive to an external environment provide external input data. An effect generator modifies the sensory output determined by the game logic based on the external input data independently of the game logic module. The sensory data could be the video output, the audio output or both. For example, if the external input relates to ambient light level, the effect generator might dim the display and quieten the audio output.

### FIELD OF THE INVENTION

This invention relates generally to the field of computer games, and in particular to a system and method for real-time downstream manipulation of screen and audio output. The invention is particularly, but not exclusively, useful for games played on mobile devices.

### BACKGROUND OF THE INVENTION

Mobile games are played using the technology present on the mobile device itself. The game is usually downloaded via the network to become resident on the device.

A game engine is a system designed for the creation and development of video games and provides a software framework that developers use to create specific games. Game engines can include a set of subsystems, some of which could be a: Renderer for 2D or 3D graphics, Physics simulator, Game logic, or a Compositor.

Game developers use a game engine to provide reuse when developing different games. Game engines also provide visual development tools, provided in an integrated development environment (IDE) to enable simplified, rapid development of games. Game engines can be architected so they allow specific systems in the engine to be replaced or extended with more specialized components.

A frame buffer is a memory buffer containing a complete circular definition of data. The information in the memory buffer consists of color values for every pixel on the screen. Rendering is the process of generating an image from a model by means of computer programs. Scene data contains geometry and textures in a strictly defined language or data structure. Scene data has two parts, static object data and dynamic object data. It contains as a description of the virtual scene: geometry, which is a set of vertices and edges, viewpoint, which is the 2D coordinates for the viewpoint+a direction vector+an up vector, texture, which is what is on each surface for each geometry unit +how it is mapped, lighting, which can be either ambient or directional, the 2D coordinates+a direction vector+the reflective quality of the geometry unit, shading information which is information on the shadows for each object+the combination of shadows and light for overlapping objects.

The data contained in the scene file is then passed to a rendering program to be processed and output to rendering buffers. The rendering buffers contain different information about the final image presented on the screen, for example: shading—how the color and brightness of a surface varies with lighting, texture-mapping—a method of applying detail to surfaces, shadows—the effect of obstructing light, reflection—mirror-like or highly glossy reflection, transparency (optics), transparency (graphic) or opacity—sharp transmission of light through solid objects, volumetric lighting—highly scattered transmission of light through solid objects or volumes of space, indirect illumination—surfaces illuminated by light reflected off other surfaces, rather than directly from a light source (also known as global illumination), depth of field—objects appear blurry or out of focus when too far in front of or behind the object in focus, motion blur—objects appear blurry due to high-speed motion, or the motion of the camera, non-photorealistic rendering—rendering of scenes in an artistic style, intended to look like a painting or drawing, non-photorealistic rendering—rendering of scenes in an artistic style, intended to look like a painting or drawing.

After the renderer populates the rendering buffers, they are consolidated into a final frame buffer by a compositor. Depending on the speed of the renderer and compositor, the frame buffers are sent at a # frames/sec rate to the video display. The compositor composes the final image for display by passively combining data taken from the rendering buffers in accordance with instructions coming from the game logic.

In some games, it is desirable to include sensor information in the scene display. Microsoft has sensor integration in Windows 8. It provides game designers with an interface to the accelerometer, compass, gyro, light sensors and more. Windows 8 also offers Sensor Fusion to enable precise orientation and location data that games can use to their advantage. This can be used to allow the user to interact with the game based on external sensory input. For example, the accelerometer can be used to control the movement of objects within the game environment.

The company Polar has the Polar H7 heart rate sensor that gives an ECG-accurate heart rate to any bluetooth ready device. Nevermind is a psychological horror puzzle game that uses a heart rate sensor to challenge the player to stay calm in uncomfortable situations. The game is currently a PC-only proof of concept.

However, any external inputs are fed to the game logic, which extracts the appropriate data from the scene database, which is then sent to the rendering buffers. The compositor then creates the scene from the data in the rendering buffers.

### SUMMARY OF THE INVENTION

Accordingly, one aspect of the invention provides a computer-implemented game resident on a device, comprising a game logic module for controlling operation of the game to create sensory output for presentation to a player; one or more inputs responsive to an external environment to provide external input data; and an effect generator configured to modify the sensory output determined by the game logic based on the external input data independently of the game logic module.

Embodiments of the invention modify the sensory output generated by the game logic, such as audio or video, just prior to presentation to the player. The modification is effected independently of the game logic. For example, the game logic may create a game environment with avatars. If a light sensor detects a low ambient light level, the video output might be modified to create a night scene, and the audio output volume might be decreased. In the case of a heart rate monitor showing a high heart rate, the video output might be blurred. Suitable noises could be added to the audio output.

By modifying the output determined by the game logic downstream in this way, a considerable simplification and saving in computational complexity can be achieved compared to modifying the scene through the game logic. Embodiments of the invention effectively provide another layer that works to modify the video and/or audio output independently of the game logic.

In the case of video, the game logic sends data taken from a scene database to a multi-pass renderer, which in turn populates rendering buffers. A compositor takes the data from the rendering buffers to create a composite video output. In accordance with embodiments of the invention, the output of the compositor is modified with the aid of a post rendering effect generator.

In accordance with another aspect the invention provides a method of implementing a game on a device, comprising: creating a game environment for a player with a game logic module; creating with the game logic module a sensory output for presentation to a player; accepting external input data from one or more inputs responsive to an external environment; and modifying the sensory output determined by the game logic based on the external input data independently of the game logic module.

In a still further aspect the invention provides a non-transient storage medium storing instructions, which when implemented on a device: create a game environment for a player with a game logic module; create with the game logic module a sensory output for presentation to a player; accept external input data from one or more inputs responsive to an external environment; and modify the sensory output determined by the game logic based on the external input data independently of the game logic module.

Typically the storage medium will contain application that can be downloaded onto the device, such as a smartphone.

### BRIEF DESCRIPTION OF THE DRAWINGS

The invention will now be described in more detail, by way of example only, with reference to the accompanying drawings, in which:

FIG. 1 shows the general architecture of the system;

FIG. 2a shows a high level view of the game software on the player device, external inputs and sensory outputs;

FIG. 2b shows more detail of the game software on the player device, various input management and video and audio output;

FIG. 3 shows an example of rendering buffers;

FIG. 4 illustrates the sensory input management software in more detail;

FIG. 5 illustrates the compositor software in more detail; and

FIG. 6 illustrates the game logic software in more detail.

FIG. 7 illustrates the audio effect compositor software in more detail.

FIG. 8 is a flow chart detailing the use of a light sensor to modify the video output.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

The base of the invention is a gaming system. Part of this system is the client side generation of frame buffers and audio output. The system is structured so that a post rendering effect generation interpreter module takes external inputs and interprets the data in a way that provides a modification to the frame buffer data at the compositing stage or to the audio file right before it is sent to the display or speakers.

Information gathered in real-time through many different inputs can affect the audio and the images, including the background, foreground, objects and characters. Inputs can include, but are not limited to the: microphone, camera, light sensors, heart-rate monitor, accelerometer, plug-in software and an analytics engine. This changes the audio that is output, or the look of the screen that is created by manipulation in any one of, or a combination of, any of the screen layers. For example, if the game is being played in a dark space vs. a light space (as determined by the light sensor), this can be reflected in how the lighting is displayed in the game. Another example is if a heart-rate monitor is hooked up to the user, and their heart-rate is seen to go up, then a distortion filter could be applied, or an actual heart beat matching that of the player could be displayed on their avatar or heard through the speakers.

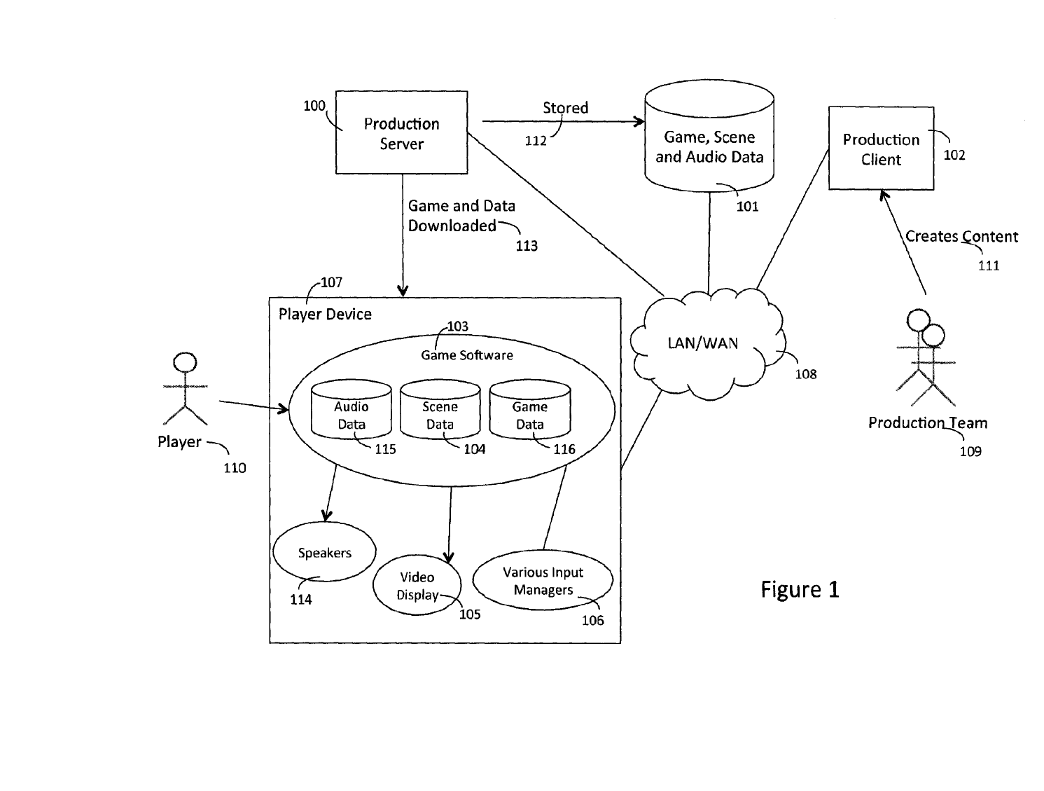

Referring to FIG. 1, the production team 109 creates content 111 for the game using a production client 102, which is connected via the LAN/WAN 108 to the production server 100. Part of the content is game, scene and audio data 101, all of which is accessible by the LAN/WAN 108. When a player 110 wants to play the game, they download the game and data 113 to the player device 107. On the player device 107 is the video display 105, the game software 103, which includes the game data 116 and the scene data 104 and the audio data 115, speakers 114 and various input managers 106 that manage the sensors like the microphone, camera, light sensor, etc. The player device is also connected to the LAN/WAN 108, typically wirelessly. The player 110 uses various controls to interact with the game software 103.

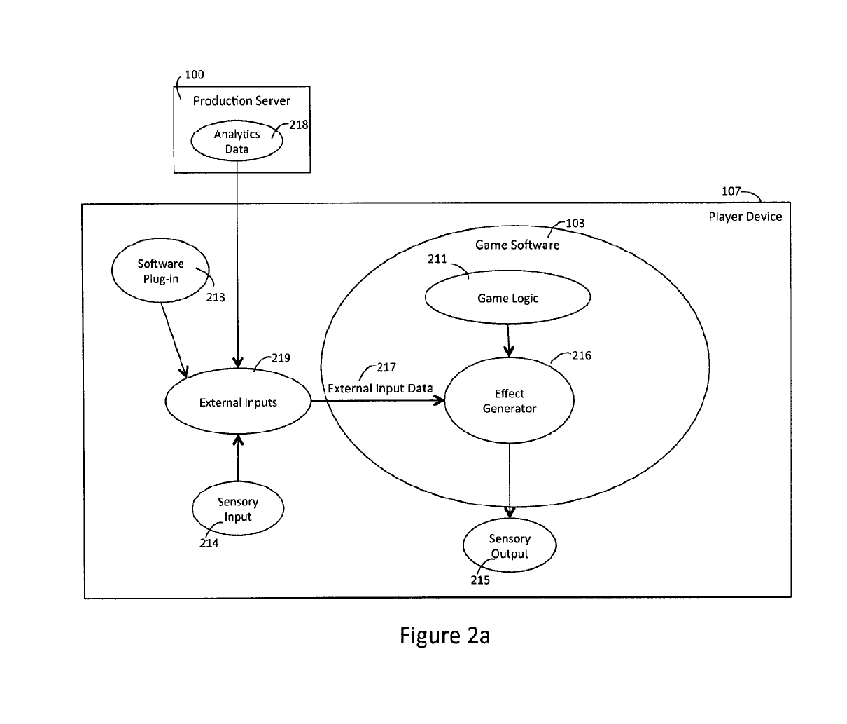

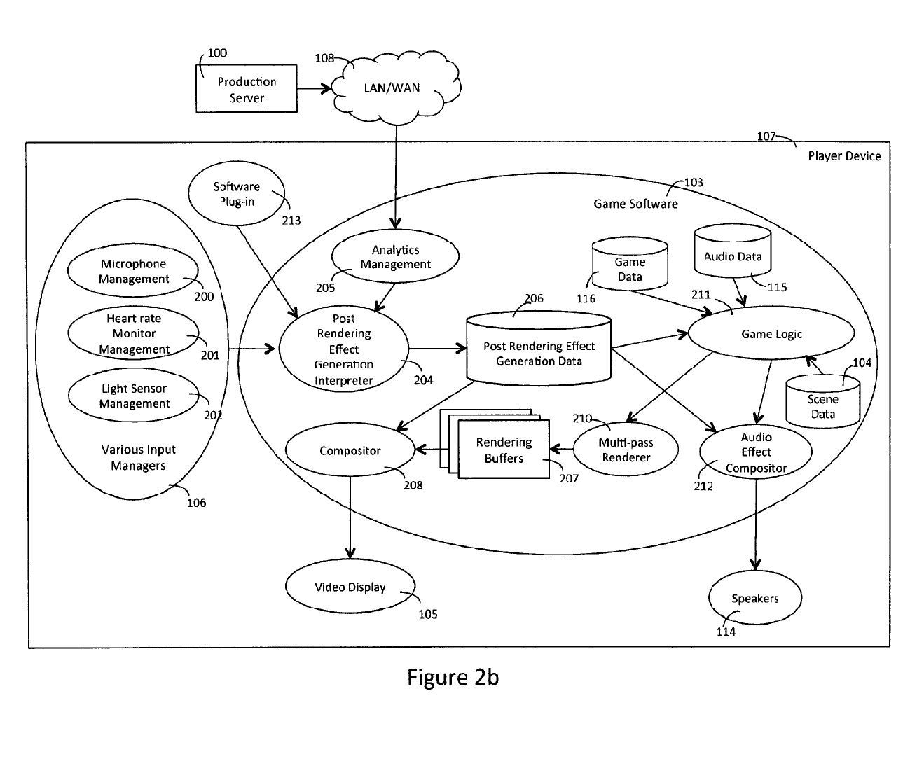

FIG. 2a shows a high level view of the game software 103 on the player device 107, external inputs 219 and sensory outputs 215. External inputs 219 can come from sensory input devices 214, software plug-ins 213 or from analytics data 218 gathered on the production server 100. External input data 217 gathered from the external inputs 219 is sent to the effect generator 216 which takes output from the game logic 211 and modifies it based on the external input data 217 which is then sent to the sensory outputs 215.

FIG. 2b shows more detail of the game software 103 on the player device 107, various input managers 106, 205 and examples of sensory output 215: video display 105 and speakers 114. Examples of various input mangers 106 are shown, which can be, but are not limited to: microphone management 200, heart rate monitor management 201, and light sensor management 202. On the production server 100, connected to the LAN/WAN 108 there can also be analytics data 218 produced which can be used as a type of input which is handled in the game software 103 by analytics management 205. This could be an accumulation of various sensors or other data sent from different player devices 107, back to the production server 100, which can consolidate it and then send a combined input back to the player device 107 game software 103. There can also be software plug-ins 213, which could be created by third parties, which can also provide input. For example, a random timer could be set, which could cause a particular filter to be temporarily added.

The post rendering effect generation interpreter 204 of the game software 103 takes all these inputs and creates new meaningful post rendering effect generation data 206, which is used by the compositor 208 or the game logic 211 or the audio effect compositor 212.

While the game is in progress, the scene data 104 is selected by the game logic 211 and is used by the multi-pass renderer 210 to populate rendering buffers 207. These are passed to the compositor 208, which takes these rendering buffers 207 and the post rendering effect generation data 206 produced by the post rendering effect generation interpreter 204 and creates the output to be displayed on the video display 105 of the player device 107. The post rendering effect generation data 206 can also be used by the game logic 211 to select the audio data 115 that is sent to the player device 107 speakers 114 through the audio effect compositor 212. The post rendering effect generation data 206 can also be used directly by the audio effect compositor 212 to change the audio being output to the speakers 114.

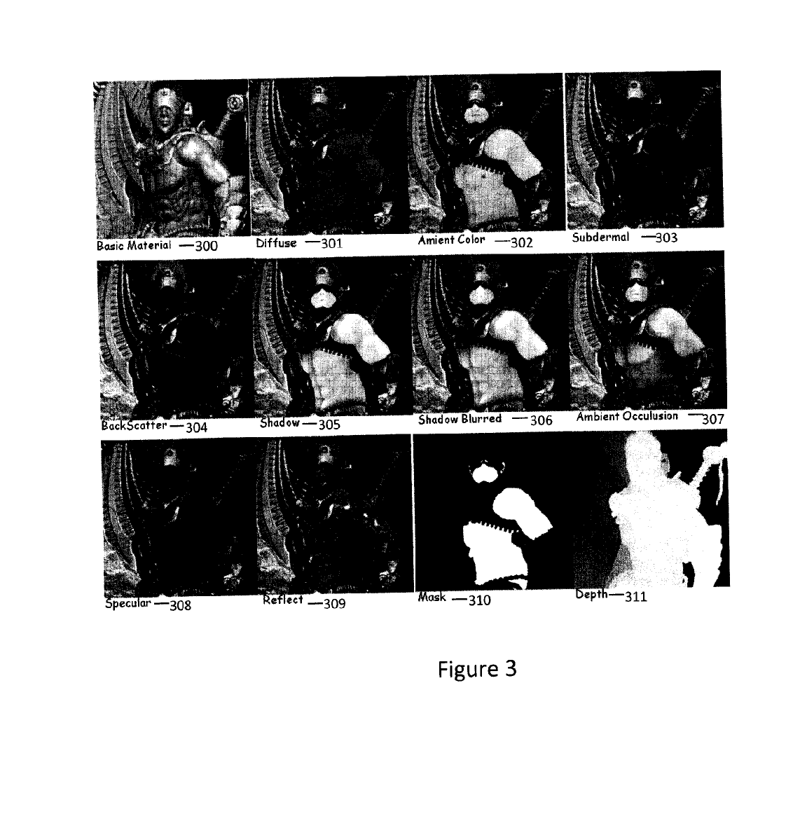

FIG. 3 (found at http://www.zbrushcentral.com) shows visual representations of rendering buffer content 207 created by the multi-pass renderer 210. These rendering buffers 207 show: basic material data 300, diffuse data 301, amient color data 302, subdermal data 303, back scatter data 304, shadow data 305, shadow blurred data 306, ambient occlusion 307, specular data 308, reflect data 309, mask data 310, and depth data 311, all representing different aspects of the final image.

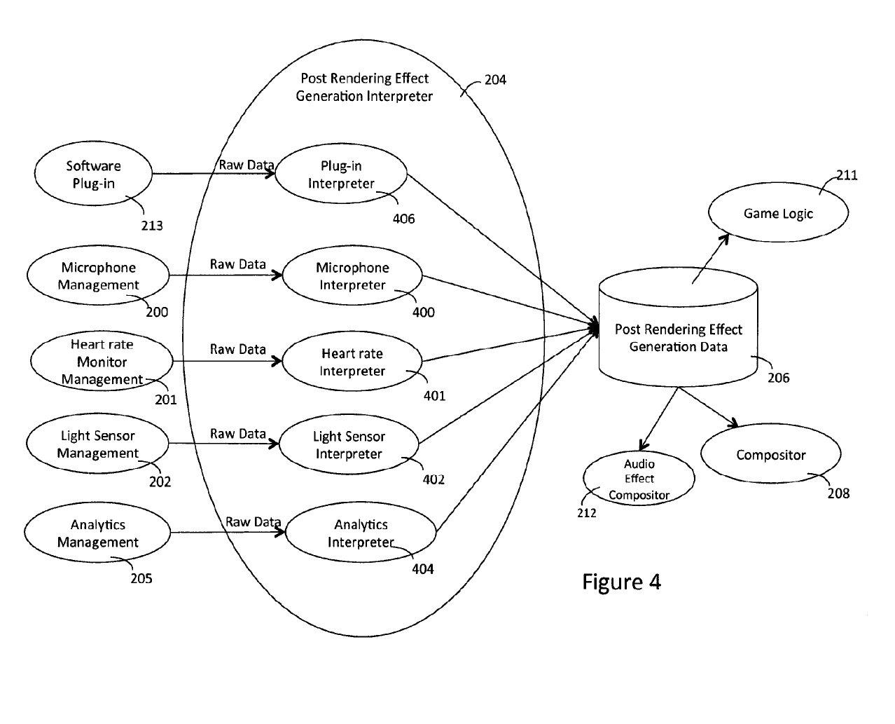

In FIG. 4, the post rendering effect generation interpreter 204 in accordance with an embodiment of the invention is made up of interpreters 400, 401, 402, 404, 406 which monitor raw data from existing sensor managers 200, 201, 202, 205 or from a software plug-in 213 and turn it into post rendering effect generation data 206 that the compositor 208 or the game logic 211 or the audio effect compositor 212 can use. This is done either by polling (a timer based mechanism that reads the data every time interval) or event driven which would inform the interpreter when new raw data arrives based on filters provided by the monitoring entity.

The microphone interpreter 400 could, for example, look at the raw microphone data for a loud noise (which would be monitoring for data passing a specific amplitude), and interpret that to mean something specific for the particular game. For example it could cause the compositor 208 to apply a particular filter to the current rendering data, or it could cause the game logic 211 to change the character's movement (e.g. make it jump), or change the audio stream (for example to insert a sound or dialogue from the character—“What was that?!”).

The heart rate interpreter 401 could for example take the raw data of beats per minute and at a specific threshold interpret that to mean the player 110 is getting excited, which could, for example, cause the compositor 208 to apply a blur filter to the current rendering data, or it could, for example, cause the game logic 211 to change the player's avatar to include a beating heart, or insert a heart beat sound which matches that of the player 110.

The light sensor interpreter 402 could, for example, take the raw data of intensity of light and interpret that to mean the game should become darker, which could prompt the compositor 208 to, for example, apply a gray filter to the current rendering data.

The analytics interpreter 404 could, for example, take the raw data of number of players currently playing the game and interpret that to mean the game background should have more people in it (for example, in the stands in an arena) which could cause the game logic 211 to choose different scene data 104 to be rendered.

The plug-in interpreter 406 could provide an API for third parties, which could let them select a particular filter to be applied based on the software plug-in 213 criteria. For example this could be a random timer in the software plug-in 213, which could cause the video to go blurry for a few seconds or to have a white noise filter applied to the audio for a few seconds.

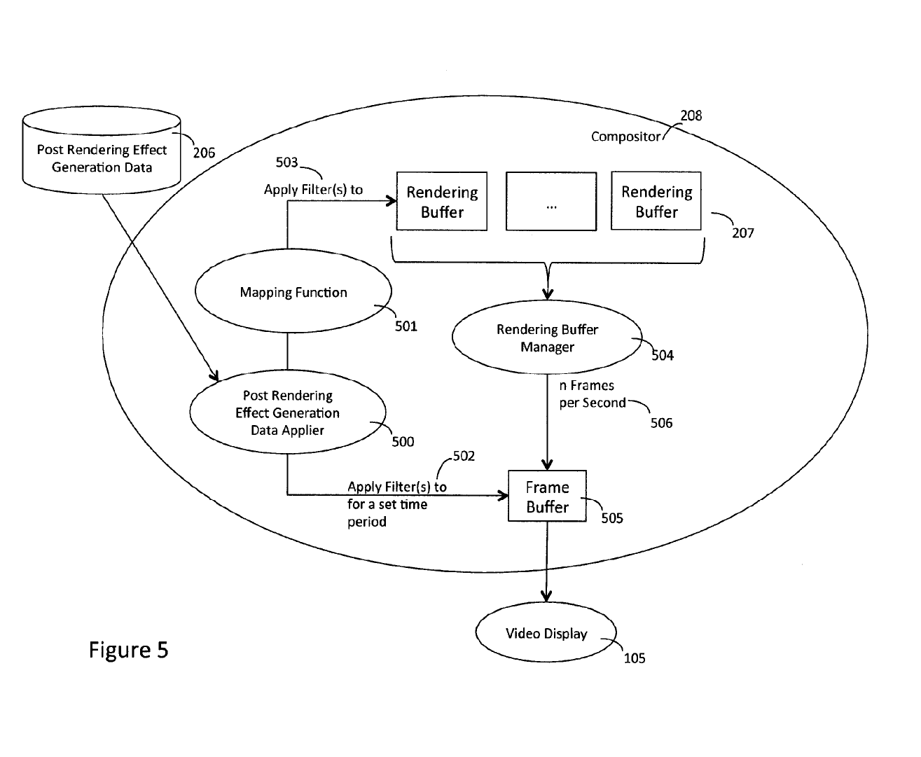

FIG. 5 shows more detail in the compositor 208. The rendering buffer manager 504 is responsible for taking all the rendering buffers 207 and combining them to create a frame buffer 505 which is sent at n frames per second 506 to the video display 105. The post rendering effect generation data applier 500 can either poll for changes in the post rendering effect generation data 206, or be informed by an event in real time when the post rendering effect generation data 206 has changed. When a change happens, it can cause the post rendering effect generation data applier 500 to, for example, apply filter(s) to for a set time period 502 the frame buffer 505. It could also use a mapping function 501 (which maps which rendering buffers should be changed and to what degree) to apply filter(s) to 503 the rendering buffers 207 before they are sent to the rendering buffer manager 504.

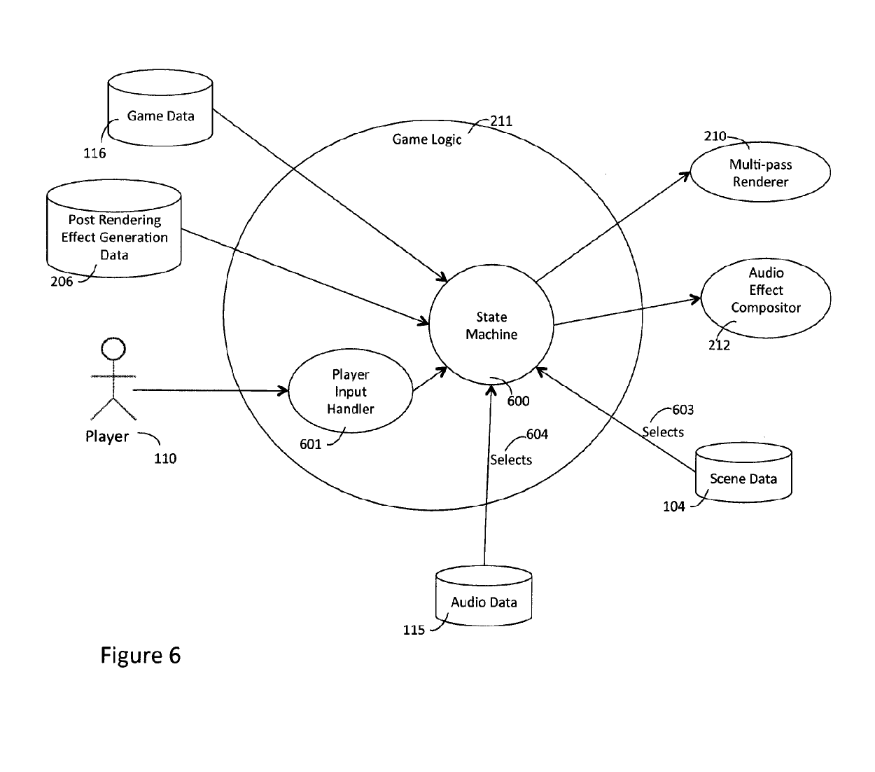

FIG. 6 shows more detail in the game logic 211. The state machine 600 has knowledge of where the player 110 is in the game and is responsible for what is being displayed and heard by the player 110 in any given situation. There is a player input handler 601 which takes input from the various controls on the player device 107. This influences the state machine 600 for the game. As well as the player having input to the state machine 600, the game data 206 and post rendering effect generation data can also provide input to the state machine 600. Based on these three inputs, the state machine 600 selects 603 the scene data 104 to be sent to the multi-pass renderer 210. It also selects 604 the audio data 115 to be sent to the speakers 114.

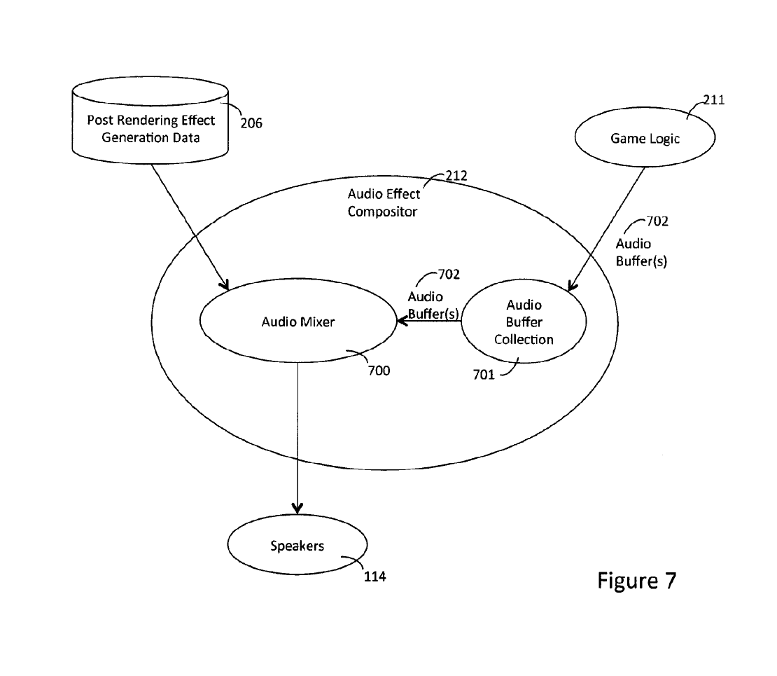

FIG. 7 shows more detail in the audio effect compositor 212. The game logic 211 gives the audio effect compositor 212 via the audio buffer collection 701 the audio buffer(s) 702 to play on the speakers 114. This audio buffer 702 is passed to the audio mixer 700, which takes the post rendering effect generation data 206 and selects an appropriate audio filter to apply to the audio buffer 702 before sending it to the speakers 114.

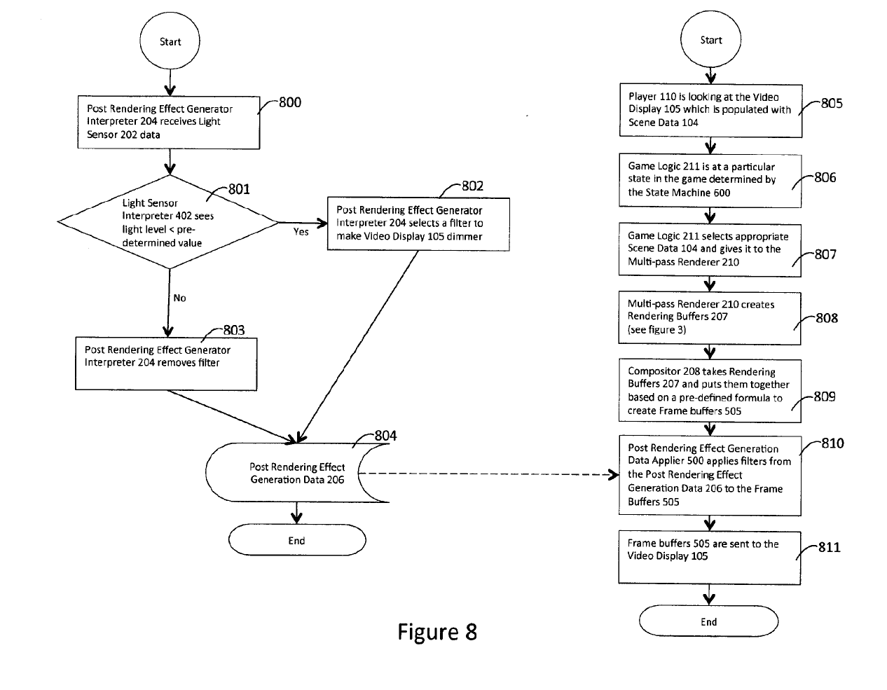

FIG. 8 is a flow chart for an exemplary embodiment wherein a light sensor is used to modify the video output. To start, box 800, the post rendering effect generator interpreter 204 receives light sensor 202 input data which it then checks, box 801, to see if the light level is above or below a pre-determined value. If it is below the pre-determined value, then, box 802, the post rendering effect generator interpreter 204 selects a filter (or filters) applied to the post rendering effect generation data 206, box 804, to make the video display 105 dimmer. If it is above the pre-determined value, box 803, then the post rendering effect generator interpreter 204 removes any filters previously applied to the post rendering effect generation data 206. Meanwhile, box 805, the player 110 is looking at the video display 105 which is populated with scene data 104. The game logic 211 is at a particular state in the game, box 806, which is determined by the state machine 600. Box 807, the game logic 211 selects appropriate scene data 104 and gives it to the multi-pass renderer 210 to render the video display 105 seen by the player 110. Box 808, the multi-pass renderer 210 creates rendering buffers 207 (see example in FIG. 3). Box 809, the compositor 208 takes rendering buffers 207 and puts them together based on a pre-determined formula to create frame buffers 505. Box 810, the post rendering effect generation data applier 500 applies filters from the post rendering effect generation data 206 (including any filters added for dimming the video display 105) to the frame buffers 505, which, box 811, are sent to the video display 105. The filters added for dimming the display will remain until they are removed from the post rendering effect generation data 206 by the post rendering effect generator interpreter 204.

It should be appreciated by those skilled in the art that any block diagrams herein represent conceptual views of illustrative circuitry embodying the principles of the invention. As is common practice in the art the block diagrams illustrated may be implemented as software modules using signal-processing techniques in a processor, such as a digital signal processor.

A processor may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. The term circuit is used herein to encompass functional blocks that may in practice be implemented in software as software modules on one or more processors.

1-27. (canceled)

28. A computer-implemented game resident on a device, comprising:
a game logic module for controlling operation of the game to create sensory output for presentation to a player;
one or more inputs responsive to an external environment to provide external input data;
an effect generator configured to modify the sensory output determined by the game logic based on the external input data independently of the game logic module; wherein
the sensory output is video output and the effect generator comprises:
a plurality of rendering buffers;
a renderer responsive to instructions from the game logic module to populate the rendering buffers;
a compositor for aggregating data from the rendering buffers to create frames of the video output for display on the device; and
a post-rendering effect generator responsive to the sensory input data to modify the video output created by the compositor, wherein either
the post-rendering effect generator is configured to modify the video output by applying a filter or filters to the output generated by the compositor from the rendering buffers; or
the post-rendering effect generator is configured to modify the video output by applying a filter or filters to the output of the rendering buffers and the computer game further comprises a mapping module for mapping changes requested by the post-rendering effect generator to the rendering buffers.

29. A computer-implemented game as claimed in claim 28, wherein the external input data is sensory input data.

30. A computer-implemented game as claimed in claim 29, wherein said one or more inputs are selected from the group consisting of: a microphone, a heart-rate monitor, and a light sensor.

31. A computer-implemented game as claimed in claim 28, wherein the post-rendering effect generator is responsive to sensory input from multiple inputs to modify the video output to change the scene elements based on the sensory data.

32. A computer-implemented game as claimed in claim 28, wherein when the post-rendering effect generator is configured to modify the video output generated by the compositor, the compositor comprises:
a rendering buffer manager for aggregating data from the rendering buffers, and a frame buffer for storing the video output, and wherein the filter is applied to the frame buffer.

33. A computer-implemented game as claimed in claim 28, wherein the sensory output is audio output, and the effect generator is configured to modify the audio output based on the external input data.

34. A computer-implemented game as claimed in claim 28, wherein said one or more inputs are selected from the group including: software plugins, and analytics management software.

35. A method of implementing a game on a device, comprising:
creating a game environment for a player with a game logic module;
creating with the game logic module a sensory output for presentation to a player;
accepting external input data from one or more inputs responsive to an external environment; and
modifying the sensory output determined by the game logic based on the external input data independently of the game logic module; wherein
the sensory output is video output, and modifying it comprises:
populating rendering buffers in response to instructions from the game logic module;
aggregating data from the rendering buffers to create frames of the video output for display on the device; and
modifying the video output created by the compositor in response to the external input data, wherein the modification is filtering the output generated by the compositor from the rendering buffers.

36. A method as claimed in claim 35, wherein the extrernal input data is sensory input data.

37. A method as claimed in claim 35, wherein said one or more inputs are selected from the group consisting of: a microphone, a heart-rate monitor, and a light sensor.

38. A method as claimed in claim 35, wherein the external input data comprises data from multiple inputs to change the scene elements based on the external input data.

39. A computer-implemented game as claimed in claim 35, wherein the sensory output is audio output, and the audio output is modified based on the external input data.

40. A computer-implemented game as claimed in claim 35, wherein said one or more inputs are selected from the group including: software plugins, and analytics management software.

41. A non-transient storage medium storing instructions, which when implemented on a device:
create a game environment for a player with a game logic module;
create with the game logic module a sensory output for presentation to a player;
accept external input data from one or more inputs responsive to an external environment; and
modify the sensory output determined by the game logic based on the external input data independently of the game logic module, wherein
the instructions cause the device to filter the output generated by the compositor from the rendering buffers to modify the video output.

42. A storage medium as claimed in claim 41, wherein the external input data is sensory input data.

43. A storage medium as claimed in claim 41, wherein said one or more inputs are selected from the group consisting of: a microphone, a heart-rate monitor, and a light sensor.

44. A storage medium as claimed in claim 41, wherein the sensory output is video output, the instructions cause the device to:
populate rendering buffers in response to instructions from the game logic module;
aggregate data from the rendering buffers to create frames of the video output for display on the device; and
modify the video output created by the compositor in response to the external input data.

45. A storage medium as claimed in claim 44, wherein the external input data comprises data from multiple inputs to change the scene elements based on the external input data.

46. A storage medium as claimed in claim 41, wherein the sensory output is audio output, and the audio output is modified based on the external input data.

47. A storage medium as claimed in claim 41, wherein said one or more inputs are selected from the group including: software plugins, and analytics management software.
